(19) United States
(12) Patent Application Publication
(10) Pub. No.: US 2024/0383812 A1
(43) Pub. Date: Nov. 21, 2024

(54) WATER-RESISTANT GYPSUM BOARDS AND LINERS FOR USE IN SAME, AND METHODS OF MAKING THEM

(71) Applicant: CertainTeed Gypsum, Inc., Malvern, PA (US)

(72) Inventors: Dahlia Amato, Malvern, PA (US); Patrick McGinley, Malvern, PA (US); William Reid, Philadelphia, PA (US); Nathan Stull, Portage, PA (US); Remi Lespiat, Devon, PA (US); Roger Jones, Fleming Island, FL (US)

(21) Appl. No.: 18/667,756

(22) Filed: May 17, 2024

Related U.S. Application Data
(60) Provisional application No. 63/529,835, filed on Jul. 31, 2023.
(60) Provisional application No. 63/503,388, filed on May 19, 2023.

(51) Int. Cl. C04B 28/14; B28B 19/00; C04B 11/26; C04B 111/00

(52) U.S. Cl. CPC C04B 28/14; B28B 19/0092; C04B 11/26; C04B 2111/0062

(57) ABSTRACT

The present disclosure relates generally to a water-resistant gypsum board including a gypsum core with a first major surface and a second, opposing major surface; a first liner having a first major surface and a second, opposing major surface, the first liner comprising at at least the first major surface thereof a condensation product of a polysiloxane comprising at least one silanol, the first major surface of the first liner being disposed against the first major surface of the gypsum core; and a second liner having a first major surface and a second, opposing major surface, the first major surface of the second liner being disposed against the second major surface of the gypsum core.

### CROSS-REFERENCE TO RELATED APPLICATIONS

This application claims the benefit of priority of U.S. Provisional Patent Application No. 63/503,388, filed May 19, 2023, and U.S. Provisional Patent application No. 63/529,835, filed Jul. 31, 2023, each of which is hereby incorporated herein by reference in its entirety.

### BACKGROUND OF THE DISCLOSURE

### 1. Field

The present disclosure relates generally to water-resistant gypsum boards, liners, and methods of making the same.

### 2. Technical Background

Gypsum building products (e.g., known variously as wallboard, ceiling board, plasterboard, sheathing, and “drywall”) are panels made of a gypsum core sandwiched between two layers of liner, often paper, on the outside surfaces of the gypsum core. They are widely used as construction materials due to their ease of fabrication, high mechanical strength, low thermal conductivity, resistance to spread of fire, and soundproofing properties. The quality of a gypsum board is strongly dependent on its gypsum core, which is fabricated by the hydration of a stucco slurry (mainly containing calcium sulfate hemihydrate) into a set body of calcium sulfate dihydrate. To control the properties of gypsum boards, additives are often added to the stucco slurry during the board making process. For example, foaming agents, inorganic compounds, and other additives may be included in the slurry to modulate the density, strength, and/or fire resistance properties of the board.

To provide water-resistant gypsum boards, commonly used for constructing spaces that are exposed to high levels of moisture (e.g., bathrooms and laundry rooms), it is common to include a silicone oil (e.g., PDMS or PMHS) to the gypsum slurry during the board making process. However, such additives only provide the gypsum core with water-resistant properties and does not provide water-resistance to the liners disposed on the outside surfaces of the core. The liners are the first defense against moisture for the board, but they are commonly made from highly absorptive materials. As such, there is need to improve the water-resistance of gypsum board liners.

### SUMMARY

In one aspect, the present disclosure provides a water-resistant gypsum board comprising:
a gypsum core with a first major surface and a second, opposing major surface;
a first liner having a first major surface and a second, opposing major surface, the first liner comprising at at least the first major surface thereof a condensation product of a polysiloxane comprising at least one silanol (e.g., a polyhydroxy-terminated polysiloxane), the first major surface of the first liner being disposed against the first major surface of the gypsum core; and
a second liner having a first major surface and a second, opposing major surface, the first major surface of the second liner being disposed against the second major surface of the gypsum core.

In another aspect, the present disclosure provides a liner for a gypsum board, the liner having a first major surface and a second, opposing major surface, the paper liner comprising at at least the first major surface thereof a polysiloxane comprising at least one silanol (e.g., a polyhydroxy-terminated polysiloxane), and/or a condensation product thereof.

In another aspect, the present disclosure provides a method for making a liner as described herein, the method comprising disposing a liquid comprising the polysiloxane comprising at least one silanol (e.g., a polyhydroxy-terminated polysiloxane) and a solvent on a first surface of a liner sheet, and allowing the liquid to dry by evaporation of the solvent.

In another aspect, the present disclosure provides a liner (e.g., as described herein) made by the method as described herein.

In another aspect, the present disclosure provides a method of producing a water-resistant gypsum board (e.g., as described herein), the method comprising:
providing a first liner having a first major surface and a second, opposing major surface, the first liner comprising at at least the first major surface thereof a polysiloxane comprising at least one silanol (e.g., a polyhydroxy-terminated polysiloxane) and/or a condensation product thereof;
disposing one or more calcium sulfate slurries between the first liner and a second liner, at least one calcium sulfate slurry being disposed against the first major surface of the first liner;
allowing the one or more calcium sulfate slurries to set to form a set gypsum body; and
drying the set gypsum body to provide a gypsum core disposed between the first liner and the second liner, and in contact with the first major surface of the first liner.

### BRIEF DESCRIPTION OF FIGURES

The accompanying drawings are included to provide a further understanding of the methods of the disclosure, and are incorporated in and constitute a part of this specification. The drawings are not necessarily to scale, and sizes of various elements may be distorted for clarity. The drawings illustrate one or more embodiment(s) of the disclosure and together with the description serve to explain the principles and operation of the disclosure.

FIG. 1 is an illustration of a water-resistant board as described herein.

FIG. 2 is an illustration of a paper liner as described herein.

FIG. 3 is a graph of the total water absorption of standard gypsum paper liners.

FIG. 4 are infrared spectra of a liner as described herein before and after drying.

FIG. 5 is a graph of the 2-hour water absorption of liners as described herein.

FIG. 6 is a graph of the total water absorption of gypsum boards with liners as described herein.

FIG. 7 is a graph of the water contact angle of liners as described herein.

FIG. 8 is a set of photographs of coated liners as described herein.

FIG. 9 is a graph of the rheology kinetics of a mixture of a polysiloxane as described herein and poly(methylhydrosiloxane).

### DETAILED DESCRIPTION

As described above, water-resistant gypsum boards are commonly used for constructing building spaces that are exposed to high levels of moisture. Additionally, it is common to include additives in the gypsum slurry during the board-making process to improve the water-resistance of the board. Such additives are commonly selected from hydrophobic materials (e.g., silicone oils). However, the present inventors have found that a majority of the water absorbed by a gypsum board is not absorbed by the gypsum core itself, but rather is absorbed by the liners disposed on the outside surfaces thereof. Accordingly, while additives provide water-resistant properties to the core, they do not provide any protection to the liners that in actuality contribute to a majority of the water absorption of the board. Thus, to provide better water-resistant gypsum boards, the water-resistance of the liners used must also be improved. As described herein, the present inventors have developed a water-resistant board that provides improved water-resistance to the board by improving the water-resistance of the liner.

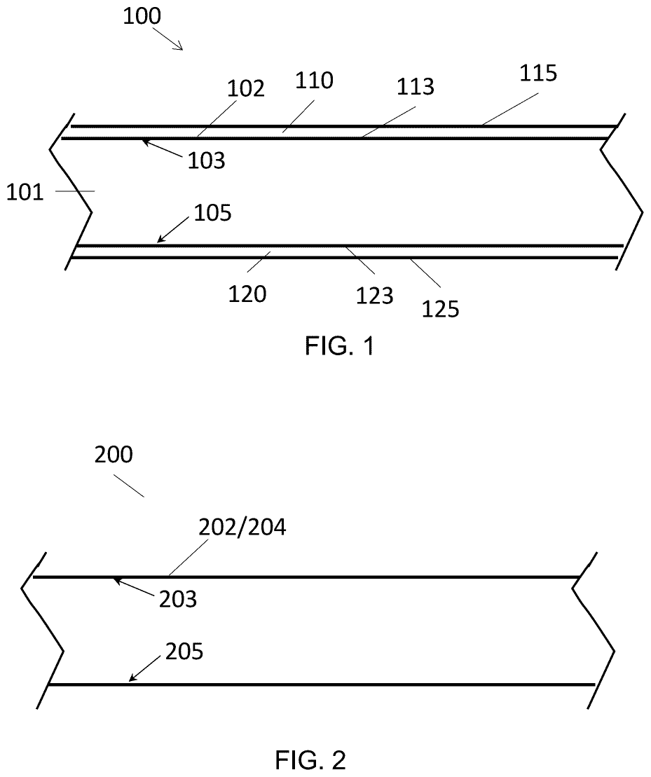

The present disclosure is concerned with water-resistant gypsum boards comprising a gypsum core, a first liner, and a second liner, and methods for making them. As such, in one aspect, the present disclosure provides a water-resistant gypsum board including a gypsum core with a first major surface and a second, opposing major surface; a first liner having a first major surface and a second, opposing major surface, the first liner comprising at at least the first major surface thereof a condensation product of a polysiloxane comprising at least one silanol, the first major surface of the first liner being disposed against the first major surface of the gypsum core; and a second liner having a first major surface and a second, opposing major surface, the first major surface of the second liner being disposed against the second major surface of the gypsum core. An example of such a gypsum board is shown in a cross-sectional schematic view in FIG. 1. Here, a water-resistant gypsum board (100) includes a gypsum core (101) with a first major surface (103) and a second, opposing major surface (105); a first liner (110) having a first major surface (113) and a second, opposing major surface (115), the first liner (110) comprising at at least the first major surface (113) thereof a condensation product (102) of a polysiloxane comprising at least one silanol, the first major surface (113) of the first liner being disposed against the first major surface (103) of the gypsum core; and a second liner (120) having a first major surface (123) and a second, opposing major surface (125).

As the person of ordinary skill in the art will appreciate, gypsum boards are typically provided with liners at opposing major surfaces thereof. In some embodiments of the disclosure as described herein, the gypsum core of the gypsum board is disposed between a first liner at a first major surface of the gypsum board and a second liner at a second, opposing major surface of the board. The liners can be formed, for example, from paper, fiberglass, foil, or fabric. In various embodiments, one or more of the liners is a fiberglass mat, which can optionally be coated at the second major surface thereof with a polymer-bound mineral layer, e.g., polymer-bound calcium carbonate. Of course, other liner materials are possible.

In some embodiments as described herein, the first liner is a paper liner. The paper liner is not particularly limited. Recycled paper can be used. In some embodiments as described herein, the paper liner has a weight of at least 32 lbs/msf (i.e., per 1000 square feet) (e.g., at least 34 lbs/msf, at least 36 lbs/msf, or at least 38 lbs/msf). In various embodiments as described herein, the paper liner has a weight in the range of 32-72 lbs/msf, or 32-68 lbs/msf, or 32-64 lbs/msf, or 34-72 lbs/msf, or 34-68 lbs/msf, or 34-64 lbs/msf, or 36-72 lbs/msf, or 36-68 lbs/msf, or 36-64 lbs/msf, or 38-72 lbs/msf, or 38-68 lbs/msf, or 38-64 lbs/msf. Of course, other types of materials can be suitable for the first liner, e.g., a polymer sheet, a foil or a fabric. In various embodiments, the first liner is a fiberglass mat, which can optionally be coated at the second major surface thereof with a polymer-bound mineral layer, e.g., polymer-bound calcium carbonate.

In some embodiments as described herein, the second liner may be the same or different from the first liner. For example, in some embodiments, the first liner and second liner are paper liners. In other embodiments, the first liner and second liner are fiberglass liners.

As described above, the first liner of the board as described herein comprises at at least the first major surface thereof a condensation product of a polysiloxane comprising at least one silanol. Advantageously, the present inventors have noted that polysiloxanes comprising at least one silanol can readily react with each other to provide the condensation product as described herein. As would be understood by the person of ordinary skill in the art, the rate limiting step in cross-linking polysiloxanes is to provide reactive oxygen-containing groups to the polysiloxane that ultimately form the siloxane (—Si—O—Si—) bonds. For example, hydrolysis of hydrogen containing polysiloxanes often require large amounts of alkaline water to provide hydroxyl groups that can then further react to form siloxane bonds. By using polysiloxanes comprising at least one silanol, the present inventors have found a faster and more efficient means to provide a condensation product on a first surface of a liner, without depending on the relatively slow alkaline hydrolysis of Si—H groups.

As would be understood by the person of ordinary skill in the art, the polysiloxane can be selected from a variety of different polysiloxanes. For example, the at least one silanol (i.e., —Si—OH) can be present at any position of the polysiloxane. In some embodiments as described herein, the at least one silanol is present on the polysiloxane backbone. Such polysiloxanes can also include both hydrogen and other functional groups to modify the polysiloxane backbone. The number of silanols can vary in the polysiloxane. For example, in some embodiments, the polysiloxane comprises at least two silanols.

In some embodiments of the disclosure as described herein, the polysiloxane is a polyhydroxy-terminated polysiloxane. In some embodiments as described herein, the polyhydroxy-terminated polysiloxane is a polysiloxane functionalized with at least one hydroxy group at two or more terminal silicon atoms of the polysiloxane. In some embodiments as described herein, a polyhydroxy-terminated polysiloxane is a polysiloxane functionalized with at least one hydroxy group at all terminal silicon atoms of the polysiloxane. For example, such polysiloxanes can have two silanols per molecule.

In some embodiments, the polysiloxane is a hydroxy-terminated alkyl-functional polysiloxane. As used herein, an alkyl-functional polysiloxane is a polysiloxane functionalized with alkyl groups along the polysiloxane backbone. For example, in some embodiments, the hydroxy-terminated polysiloxane includes a methyl-functional polysiloxane, an ethyl-functional polysiloxane, a propyl-functional polysiloxane, or a butyl-functional polysiloxane. In some embodiments as described herein, the polysiloxane is a hydroxy-terminated polydimethylsiloxane. In some embodiments, the polysiloxane is a hydroxy-terminated polymethylhydrosiloxane. However, in many embodiments, no more than 10 wt %, e.g., no more than 5 wt % of or no more than 1 wt % of polysiloxane of the liner is polymethylhydrosiloxane or derived therefrom. In many embodiments, it is desirable that the molar content of dimethylsiloxane units in the polysiloxane is at least 90%, e.g., at least 95% or at least 99% of the non-terminal siloxane units of the polysiloxane.

The polysiloxanes as described herein may be selected from polysiloxanes having a range of molecular weights and degrees of polymerization. For example, in some embodiments as described herein, the polysiloxanes as described herein have a number-average molecular weight no more than 8000 g/mol. In various embodiments as described herein, the polysiloxanes have a molecular weight of no more than 7000 g/mol, or no more than 6000 g/mol. In various embodiments as described herein, the polysiloxanes have a number-average molecular weight of at least 1000 g/mol, e.g., at least 2000 g/mol or at least 3000 g/mol. Molecular weights of polysiloxanes are measured using gel permeation chromatography using columns based on highly cross linked, porous polystyrene/divinylbenzene matrix (available from Agilent under the name PLgel), using methyl-terminated poly(dimethylsiloxane) as standards.

As would be understood by the person of ordinary skill in the art, the molecular weight and degree of polymerization of the polysiloxane influences various physical properties of the polysiloxane, including viscosity. In some embodiments as described herein, the polysiloxane has a viscosity in the range of 25-500 cP. For example, in various embodiments, the polysiloxane has a viscosity in the range of 25-300 cP, or 25-150 cP, or 25-100 cP, or 50-500 cP, or 50-300 cP, or 50-150 cP, or 50-100 cP.

As described above, the first liner comprises at at least the first major surface thereof a condensation product of a polysiloxane as described herein. As would be understood by the person of ordinary skill in the art, the condensation product of the polysiloxane results from any condensation reaction between any silanol groups present in the polysiloxane. The condensation product as described herein may be a partial or complete condensation product of the polysiloxanes as described herein, i.e., not all of the silanols must react in order to provide a condensation product. In some embodiments as described herein, the condensation product of the polysiloxane is provided without a catalyst (e.g., without a metal oxide catalyst). In some embodiments as described herein, the first liner does not include an antimicrobial agent at the first major surface thereof.

The amount of the condensation product of the polysiloxane of the first liner can be varied by the person of ordinary skill in the art in accordance with the description herein. In various embodiments, the first liner comprises at least 1 g/m² of the condensation product of the polysiloxane as described herein, e.g., at least 3 g/m² or at least 5 g/m², or at least 7 g/m². For example, in various embodiments, the first liner comprises in the range of 1-50 g/m² of the condensation product of the polysiloxane, e.g., 1-40 g/m², or 1-30 g/m², or 1-20 g/m². In various embodiments, the first liner comprises in the range of 3-50 g/m² of the condensation product of the polysiloxane, e.g., 3-40 g/m², or 3-30 g/m², or 3-20 g/m². In various embodiments, the first liner comprises in the range of 5-50 g/m² of the condensation product of the polysiloxane, e.g., 5-40 g/m², or 5-30 g/m², or 5-20 g/m². In various embodiments, the first liner comprises in the range of 7-50 g/m² of the condensation product of the polysiloxane, e.g., 7-40 g/m², or 7-30 g/m², or 7-20 g/m².

As would be understood by the person of ordinary skill in the art, the materials of the liners as described herein are often porous; for example, paper liners typically have a degree of porosity into which liquids can enter. As such, in some embodiments, the condensation product of the polysiloxane may extend into a thickness of the first liner. For example, in various embodiments, the condensation product of the polysiloxane extends into at most 90%, or at most 80%, or at most 70%, or at most 60%, of a thickness of the first liner. In various embodiments as described herein, the condensation product of the polysiloxane extends into at least 10%, or at least 20%, or at least 30%, or at least 40%, of a thickness of the first liner.

In some embodiments as described herein, the condensation product does increase the thickness of the first liner. For example, in various embodiments, the thickness of the first liner is at least 10 μm, or at least 15 μm, or at least 20 μm, or at least 25 μm, greater than an otherwise identical liner that does not have the condensation product of a polysiloxane comprising at least one silanol.

But while the condensation product of the polysiloxane extends into the first liner, advantageously, the present inventors have found that it can be advantageous for the condensation product to not affect the properties of the non-coated side (i.e., the second, opposing major surface of the first liner). This non-coated side, also commonly referred to as the face side, defines the outer surface of the gypsum board and the aesthetics of the board. Additionally, it is this side of the liner that is often further coated with paint and/or joint compound upon installation of the gypsum board. As such, it is important that the second surface of the liner is substantially unaffected by the condensation product on the first surface of the liner. One such property of the second surface of the liner that is desirably not affected by the condensation product is the water contact angle. For example, in various embodiments as described herein, the first liner has a water contact angle at the second major surface thereof that is no more than 5° (e.g., no more than 4°, or no more than) 3°) greater than a water contact angle of an otherwise identical liner that does not have the condensation product of a polysiloxane comprising at least one silanol. Conversely, the water contact angle of the first liner at the first major surface thereof is affected by the condensation product as described herein. In some embodiments as described herein, the first liner has a water contact angle at the first major surface thereof that is at least 5° (e.g., at least 7°, or at least 10°) greater than a water contact angle of an otherwise identical liner that does not have the condensation product of a polysiloxane comprising at least one silanol. In some embodiments, the first liner has a water contact angle at the first major surface thereof that is in the range of 5-20° (e.g., 5-15 7°, or 5-12°, or 7-20°, or 7-15, or 7-12°, or 10-20°, or 10-15°) greater than a water contact angle of an otherwise identical liner that does not have the condensation product of a polysiloxane comprising at least one silanol

In some embodiments as described herein, the first liner has a water contact angle in the range of 115-135° (e.g., in the range of 115-130°, or 115-125°, or 120-135°, or 120-130°, or 120-125°) at the first major surface thereof (e.g., before being contacted with the calcium sulfate slurry). In some embodiments, the first liner has a water contact angle in the range of 120-140° (e.g., in the range of 120-135°, or 120-130°, or 125-140°, or 125-135°, or 125-130°) at the second major surface thereof. Water contact angles can be determined using contact angle goniometry using deionized water.

As described below, the person of ordinary skill in the art, based on the present disclosure, can provide polysiloxane at the first major surface of the liner in such an amount that it does not soak through the entirety of the liner to substantially affect properties of the second major surface thereof.

As noted above, providing water-resistant liners to gypsum boards can improve the overall water-resistance of the board. As such, in some embodiments as described herein, the first liner does not absorb a substantial amount of water. One way to measure the water-resistance properties of the liner is to measure the total water absorption. Such measurements are performed as described in ASTM C473-17, which requires submersion of the entire liner in water for 2 hours. Lower water absorption is indicative of better water-resistance. For example, in some embodiments, the first liner has a total water absorption of no more than 10 wt %, based on the weight of the liner. In some embodiments, the first liner has a total water absorption of no more than 5 wt %, or no more than 2.5 wt %, based on the weight of the liner.

As described above, the water-resistant gypsum boards also include a second liner. In some embodiments as described herein, the second liner comprises at at least the major surface thereof a condensation product of a polysiloxane comprising at least one silanol. In some embodiments as described herein, the second liner is as described for the first liner as described herein. In some embodiments, the second liner is different from the first liner as described herein. In some embodiments as described herein, the second liner is a fiberglass liner.

As described above, the water-resistant gypsum board comprises a gypsum core. Such a core can be provided from a calcium sulfate slurry comprising stucco and water. The stucco is desirably present in the calcium sulfate slurry to provide a gypsum core comprising mostly gypsum. For example, in various embodiments, the gypsum core comprise at least 75% gypsum, at least 80 wt % gypsum, or at least 85 wt % gypsum. As is known in the art, stucco can have a variety of compositions depending on the source and application at hand. As used herein, a “stucco” is a material having at least 75 wt % of calcium sulfate hemihydrate. It is typically provided by calcining gypsum to convert the dihydrate of gypsum to hemihydrate. Real-world samples of stucco typically include, together with the hemihydrate (e.g., present as α-calcium sulfate hemihydrate, β-calcium sulfate hemihydrate, or combinations thereof), one or more of calcium sulfate dihydrate, calcium sulfate anhydrate, and inert calcium sulfate.

While not described in detail here, one or more additives can be provided in the gypsum core of the board. For example, in some embodiments, the additives are selected from one or more accelerators, fluidizers, retarders, dispersants, foaming agents, water resistance agents, and/or glass fibers. In some embodiments, the additives are present in an amount of no more than 10 wt % of the mass of the gypsum core. In various embodiments, the additives are present in an amount of no more than 8 wt % or no more than 5 wt % of the mass of the gypsum core. The person of ordinary skill in the art will use an appropriate set of additives for a desired gypsum core material.

As described above, it is common to include silicone oil (e.g., polymethylhydrosiloxane) to the gypsum core to impart water-resistance to the gypsum core. As such, in some embodiments as described herein, the gypsum core comprises at the first major surface thereof a hydrolysis and condensation product of a polysiloxane having silicone hydride moieties. In some embodiments as described herein, the polysiloxane having silicone hydride moieties is poly(methylhydrosiloxane). Advantageously, the present inventors have noted that the polysiloxanes comprising at least one silanol will readily react with hydrolyzed polysiloxanes present at the first major surface of the gypsum core. Without being bound by theory, the present inventors hypothesize that the network of polysiloxanes produced at the interface of the gypsum core and the liner provides a barrier that ultimately improves water-resistance. Additionally, this network provides better adhesion between the core and the liner that improves the overall lifetime of the gypsum board. Accordingly, as described elsewhere herein, it can be desirable to use a liner in the fabrication of the gypsum board in which the silanols of the polysiloxane are only partially crosslinked, to leave free silanols for reaction with the polysiloxane used in the gypsum material.

As noted above, the use of the first liner as described herein can provide gypsum boards with good water-resistance. One way to measure the water-resistance properties of the board is to measure the total water absorption. Such measurements are performed as described in ASTM C473-17, which can be used to measure the water absorption of gypsum boards. Lower water absorption is indicative of better water-resistance. In some embodiments, the water-resistant gypsum board as described herein has a total water absorption of no more than 20 wt % (e.g., no more than 17 wt. %, or no more than 15 wt %), based on the weight of the board. For example, in some embodiments, the water-resistant gypsum board as described herein has a total water absorption as measured by ASTM C473-17 of no more than 10 wt %, or no more than 7.5 wt %, or no more than 5 wt %, based on the weight of the board.

Another aspect of the present disclosure as described herein provides a liner for a gypsum board, the liner having a first major surface and a second, opposing major surface, the liner comprising at at least the first major surface thereof a polysiloxane comprising at least one silanol (e.g., a polyhydroxy-terminated polysiloxane), and/or a condensation product thereof. The liners can be as described above for the first liner, e.g., formed, from paper, fiberglass, foil, or fabric. Of course, other liner materials are possible. In some embodiments as described herein, the liner is a paper liner. The paper liner is not particularly limited. In some embodiments as described herein, the paper liner has a weight of at least 32 lbs/msf (e.g., at least 34 lbs/msf, at least 36 lbs/msf, or at least 38 lbs/msf). In various embodiments as described herein, the paper liner has a weight in the range of 32-72 lbs/msf, or 32-68 lbs/msf, or 32-64 lbs/msf, or 34-72 lbs/msf, or 34-68 lbs/msf, or 34-64 lbs/msf, or 36-72 lbs/msf, or 36-68 lbs/msf, or 36-64 lbs/msf, or 38-72 lbs/msf, or 38-68 lbs/msf, or 38-64 lbs/msf. The polysiloxane of the liner is as described herein for the polysiloxane of the first liner. An example of such a liner is shown in a cross-sectional schematic view in FIG. 2. Here, liner (200) for a gypsum board has a first major surface (203) and a second, opposing major surface (205), the liner comprising at at least the first major surface (203) thereof a polysiloxane comprising at least one silanol (204), and/or a condensation product thereof (202). In some embodiments as described herein, the liner is the first liner as described herein.

The liner comprises at at least the first major surface thereof a polysiloxane comprising at least one silanol (e.g., a polyhydroxy-terminated polysiloxane), and/or a condensation product thereof. Similar to the case for the first liner as described above, in some embodiments, the liner comprises at at least the first major surface thereof a polysiloxane comprising at least one silanol (e.g., a polyhydroxy-terminated polysiloxane), and/or a condensation product thereof. In some embodiments as described herein, the condensation product of the polysiloxane is provided without a catalyst (e.g., without a metal oxide catalyst). In some embodiments as described herein, the liner does not include an antimicrobial agent at the first major surface thereof.

As would be understood by the person of ordinary skill in the art, the materials of the liners as described herein are often porous. As such, in some embodiments, the silanol-containing polysiloxane and/or condensation product of the polysiloxane may extend into a thickness of the liner. However, the present inventors have determined that is it is undesirable for the silanol-containing polysiloxane and/or the condensation product thereof to extend to the opposing second surface of the liner. For example, in various embodiments, the silanol-containing polysiloxane and/or the condensation product thereof extends into at most 90%, or at most 80%, or at most 70%, or at most 60%, of a thickness of the liner. In various embodiments as described herein, the silanol-containing polysiloxane and/or the condensation product thereof extends into at least 10%, or at least 20%, or at least 30%, or at least 40%, of a thickness of the liner.

Advantageously, the present inventors have noted that when the silanol-containing polysiloxane and/or the condensation product thereof does not extend to the second, opposing major surface of the liner (i.e., the non-coated side), it has little if any effect the properties thereof. This non-coated side, also commonly referred to as the face side, defines the outer surface of the gypsum board and the aesthetics of the board. Additionally, it is this side of the liner that is often further coated with paint and/or joint compound upon installation of the gypsum board. As such, it is important that the second surface of the liner is not affected much by the silanol-containing polysiloxane and/or the condensation product thereof disposed at the first surface of the liner. One such property of the second surface of the liner that is desirably not significantly affected by the condensation product is the water contact angle. For example, in various embodiments as described herein, the liner has a water contact angle (measured at 23 degrees under standard conditions) at the second major surface thereof that is no more than 3° (e.g., no more than 2°, or no more than 1°) greater than a water contact angle of an otherwise identical liner that does not have the condensation product of a polysiloxane comprising at least one silanol. Conversely, the water contact angle of the liner at the first major surface thereof is significantly affected by the condensation product as described herein. In some embodiments as described herein, the liner has a water contact angle at the first major surface thereof that is at least 6° (e.g., at least 8°, or at least 10°) greater than a water contact angle of an otherwise identical liner that does not have the condensation product of a polysiloxane comprising at least one silanol. In some embodiments as described herein, the liner has a water contact angle in the range of 115-135° (e.g., in the range of 115-130°, or 115-125°, or 120-135°, or 120-130°, or 120-125°) at the first major surface thereof. In some embodiments, the liner has a water contact angle in the range of 120-140° (e.g., in the range of 120-135°, or 120-130°, or 125-140°, or 125-135°, or 125-130°) degrees at the second major surface thereof.

In some embodiments as described herein, the silanol-containing polysiloxane and/or the condensation product does increase the thickness of the liner somewhat, e.g., in the range of 10-50 microns, for example, 10-40 microns, or 10-30 microns, or 15-50 microns, or 15-40 microns, or 15-30 microns, or 20-50 microns, or 20-40 microns, or 20-30 microns as compared to an otherwise identical liner that does not have the polysiloxane comprising at least one silanol and/or the condensation product thereof.

The liner as described herein can in many embodiments provide good water-resistance. As such, in some embodiments as described herein, the liner does not absorb a substantial amount of water. One way to measure the water-resistance properties of the liner is to measure the total water absorption. Such measurements are performed as described in ASTM C473-17, which requires submersion of the entire liner in water for 2 hours. Lower water absorption is indicative of better water-resistance. In some embodiments, the liner has a total water absorption of no more than 10 wt %, based on the weight of the liner. For example, in various embodiments, the liner has a total water absorption as measured by ASTM C473-17 of no more than 5 wt %, or no more than 2.5 wt %, based on the weight of the liner.

Another aspect of the present disclosure provides a method of making a liner as described herein. The method includes disposing a liquid comprising the polysiloxane and a solvent on a first surface of a liner sheet, and allowing the liquid to dry by evaporation of the solvent.

The choice of solvent is not particularly limited and any solvent that is compatible with polysiloxanes may be used. In some embodiments as described herein, the solvent has a boiling point of no more than 120° C. (e.g., no more than 110° C., no more than 100° C., or no more than 90° C.). In some embodiments as described herein, the solvent is a C₁-C₄ alcohol. For example, in some embodiments, the solvent is selected from methanol, ethanol, propanol, or butanol. In some embodiments as described herein, the solvent is isopropanol.

In some embodiments as described herein, the polysiloxane is present in the liquid in an amount in the range of 10 to 60 wt %. For example, in various embodiments, the polysiloxane is present in the liquid an amount in the range of 10 to 50 wt %, or 10 to 40 wt %, or 10 to 30 wt %, or 15 to 60 wt %, 15 to 50 wt %, or 15 to 40 wt %, or 15 to 30 wt %, or 20 to 60 wt %, or 20 to 50 wt %, or 20 to 40 wt %, or 25 to 60 wt %, or 25 to 50 wt %, or 25 to 40 wt %, or 30 to 60 wt %, or 30 to 50 wt %, or 30 to 40 wt %. The present inventors have found that using various such concentrations can provide for a desirably uniform distribution of polysiloxane at the first major surface of the liner. But the person of ordinary skill in the art will appreciate that other concentrations can be used.

Advantageously, the amount of polysiloxane and the choice of solvent provides a liquid that can be easily applied to the paper sheet. For example, in some embodiments as described herein, the liquid has a viscosity in the range of 1-10 cP. For example, in various embodiments, the liquid has a viscosity in the range of 1-5 cP, or 1-3 cP, or 2-10 cP, or 2-5 cP, or 2-3 cP.

The amount of the polysiloxane applied to the first liner can be varied by the person of ordinary skill in the art in accordance with the description herein. In various embodiments, the amount of the polysiloxane applied to the first liner is at least 1 g/m², e.g., at least 3 g/m² or at least 5 g/m², or at least 7 g/m². For example, in various embodiments, the amount of the polysiloxane applied to the first liner is in the range of 1-50 g/m², e.g., 1-40 g/m², or 1-30 g/m², or 1-20 g/m². In various embodiments, the amount of the polysiloxane applied to the first liner is in the range of 3-50 g/m², e.g., 3-40 g/m², or 3-30 g/m², or 3-20 g/m². In various embodiments, the amount of the polysiloxane applied to the first liner is in the range of 5-50 g/m², e.g., 5-40 g/m², or 5-30 g/m², or 5-20 g/m². In various embodiments, the amount of the polysiloxane applied to the first liner is in the range of 7-50 g/m², e.g., 7-40 g/m², or 7-30 g/m², or 7-20 g/m².

The method of application of the liquid to the paper sheet is not particularly limited. For example, in various embodiments as described herein, the liquid is disposed on the paper sheet by rod coating, curtain coating, spraying, printing, reverse roll coating, or gravure coating.

As described in detail below, while it is desirable that the polysiloxane be provided at the first major surface of the liner, it is also desirable that the polysiloxane not be substantially present at the second major surface of the liner. When the polysiloxane bleeds through to the second major surface, it can cause issues with later coating of the paper liner, e.g., by paint or joint compound. Accordingly, in various embodiments, the disposing of the liquid comprising the polysiloxane and the solvent on the first major surface of the liner sheet is performed such the liquid does not wet the second major surface of the liner sheet. The person of ordinary skill in the art can control this, e.g., by disposing only a limited amount of the liquid on the first major surface, such that it does not bleed through to the second major surface. This can be, for example, assessed visually during the coating process, or can be measured by the contact angle measurements described above. The person of ordinary skill in the art can adapt such methods to provide a desired amount of the polysiloxane-containing liquid such that it coats the first major surface and extends substantially into liner from the first major surface, but does not substantially extend all the way to the second major surface.

As described above, the method of making a paper liner includes allowing the liquid to dry by evaporation of the solvent. The person of ordinary skill in the art would be able to select an appropriate temperature to allow the evaporation of the solvent based on properties of the solvent. For example, in some embodiments, allowing the liquid to dry may be conducted at ambient temperatures or at elevated temperatures. In some embodiments as described herein, the drying is conducted at a temperature of at least 80° C. (e.g., at least 90° C., or at least 100° C.). In some embodiments, the drying is conducted at a temperature in the range of 80-120° C. For example, in various embodiments, the drying is conducted at a temperature in the range of 80-110° C., or 80-100° C., or 90-120° C., or 90-110° C., or 90-100° C., or 100-120° C., or 100-110° C. When drying at elevated temperature, the drying may be conducted in an oven.

In various embodiments as described herein, the drying is conducted for a time sufficient to provide the condensation product as described herein. As described above, the condensation product may be a partial or a complete condensation product of the polysiloxane as described herein. Without intending to be bound by theory, the inventors note that it can be desirable in some embodiments to provide an only partial condensation product, so as to leave a tenacious coating on the liner, but still provide free silanols for reaction with any silanols in the slurry that is disposed against the liner.

For example, in various embodiments, the drying is conducted for at least 30 minutes, at least 45 minutes, or at least 60 minutes. In various embodiments as described herein, the drying is conducted for a time in the range of 30-90 minutes, or 30-75 minutes, or 30-60 minutes, or 45-90 minutes, or 45-75 minutes, or 45-60 minutes.

Another aspect of the present disclosure provides a liner as described herein made by the methods as described herein.

Another aspect of the present disclosure provides a method of producing a water-resistant gypsum board, for example a water-resistant gypsum board as described herein. The method includes providing a first liner having a first major surface and a second, opposing major surface, the first liner comprising at at least the first major surface thereof a polysiloxane comprising at least one silanol and/or a condensation product thereof; disposing one or more calcium sulfate slurries between the first liner and a second liner, at least one calcium sulfate slurry being disposed against the first major surface of the first liner; allowing the one or more calcium sulfate slurries to set to form a set gypsum body; and drying the set gypsum body to provide a gypsum core disposed between the first liner and the second liner, and in contact with the first major surface of the first liner.

In some embodiments as described herein, the first liner is a paper liner as described herein. In some embodiments as described herein, the first liner is provided by the methods as described herein.

As described above, the method as described herein includes providing one or more calcium sulfate slurries. In some embodiments, the one or more calcium sulfate slurries is formed by combining stucco and water. As the person of ordinary skill in the art will appreciate, the water provides fluidity to the slurry for ease of handling, as well as provides the necessary water for hydration of the hemihydrate to gypsum. The person of ordinary skill in the art will select a desirable ratio of stucco to water. In various embodiments of the present disclosure, the weight ratio of stucco to water in the slurry is no more than 3:1, e.g., no more than 5:2, or no more than 2:1, or no more than 7:4, or no more than 3:2. For example, in various embodiments, the weight ratio of stucco to water is in the range of 3:1 to 1:2, or 2:1 to 4:7, or 3:1 to 2:3, or 3:1 to 1:1, or 5:2 to 1:2, or 5:2 to 4:7, or 5:2 to 2:3, or 5:2 to 1:1, or 2:1 to 1:2, or 2:1 to 4:7, or 2:1 to 2:3, or 2:1 to 1:1, or 7:4 to 1:2, or 7:4 to 4:7, or 7:4 to 2:3, or 7:1 to 1:1, or 3:2 to 1:2, or 3:2 to 4:7, or 3:2 to 2:3, or 3:2 to 1:1. The stucco is desirably present in the calcium sulfate slurry to provide a gypsum core comprising mostly gypsum. For example, in various embodiments, the gypsum core comprises at least 75% gypsum, at least 80 wt % gypsum, or at least 85 wt % gypsum.

The method also includes allowing the calcium sulfate slurry to set to form a set gypsum body. As the person of ordinary skill in the art will appreciate, a calcium sulfate slurry as described herein will set over time to form a set gypsum body. Accelerators or retarders in the slurry can be used to adjust set time. The person of ordinary skill in the art can use conventional board manufacturing lines to form the set gypsum body between the liners as described herein to make building boards.

As described above, the method includes drying the set gypsum body to provide the gypsum core. In some embodiments, drying occurs at a temperature in the range of 50-350° C. or 50-300° C. (i.e., measured in the environment above the board during drying, e.g., in a drying oven) to provide the gypsum core. For example, in various embodiments, drying occurs at a temperature in the range of 100-350° C., or 100-325° C., or 100-300° C., or 150-350° C., or 150-325° C., or 150-300° C., or 200-350° C., or 200-325° C., or 200-300° C. Drying may be accomplished with an oven, wherein the oven temperature is in the range of 50-350° C., or 50-325° C., or 50-300° C., or 100-350° C., or 100-325° C., or 100-300° C., or 150-350° C., or 150-325° C., or 150-300° C., or 200-350° C., or 200-325° C., or 200-300° C. During the drying step, the temperature of the gypsum core desirably does not exceed 125° C., e.g., does not exceed 120° C., 115° C., 110° C., or 105° C. The person of ordinary skill in the art can use conventional drying methods in practicing the methods and boards of the disclosure.

### EXAMPLES

The Examples that follow are illustrative of specific embodiments of the products and methods of the disclosure, and various uses thereof. They are set forth for explanatory purposes only, and are not to be taken as limiting the scope of the disclosure.

### Example 1. Importance of Liner for Water Resistance of Gypsum Board

To qualify as water-resistant, a gypsum board must pass the Water Resistant of Core-Treated Water-Repellant Gypsum Panel Products test in accordance with ASTM C473-17. To pass this ASTM, the gypsum board must have less than total water absorption of no more than 5 wt %, based on the weight of the board.

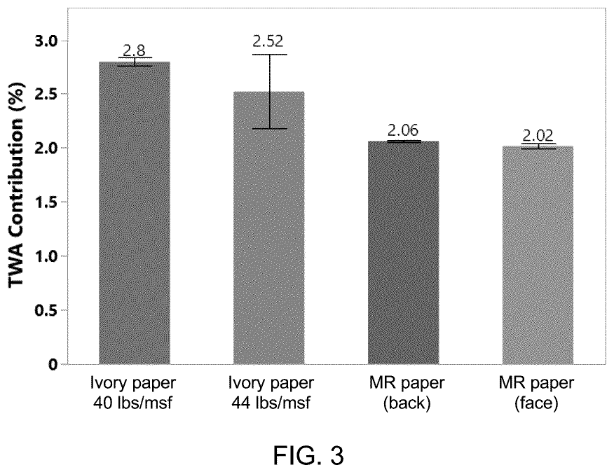

Conventional gypsum boards (including the liner) where tested in line with ASTM C473-17 and it was found that the liner was a major contributor to the water absorption. Specifically, for four different types of paper, approximately 2 wt % of the total water absorption was absorbed by the paper (based on a standard 2400 lbs/msf board). The types of paper tested and total water absorption observed are reported in Table 1 and FIG. 3.

TABLE 1

| Paper | Total Water Absorption (%) |
|---|---|
| Ivory paper 40 lbs/msf (face) | 2.8 |
| Ivory paper 44 lbs/msf (face) | 2.52 |
| MR paper (back) | 2.06 |
| MR paper (face) | 2.02 |

Thus, improving the water-resistance of the liner can greatly impact the overall water-resistance of the board.

### Example 2. Preparation of Liner

To improve the water-resistance of a liner, a coating, prepared from a solution of hydroxy-terminated poly(dimethylsiloxane) (20 wt % in isopropanol), was applied to a paper liner (PAL MR paper). The polysiloxane used was a hydroxy-terminated polydimethylsiloxane having a viscosity of 80 cP, about 5000 g/mol in number-average molecular weight. The polysiloxane solution was disposed on a paper liner using a 2 mil (50 μm) Meyer rod. The coating was only applied to one side of the liner and spread to each edge of the liner. The coated paper liner was then placed in an oven for 60 minutes at 100° C. to evaporate the solvent.

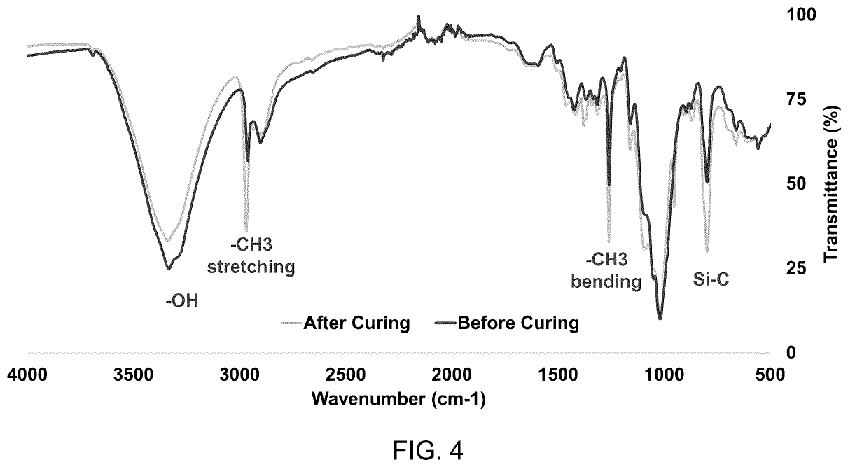

Infrared spectra were taken of the paper before and after the drying step described above. The spectra are shown in FIG. 4. As can be seen in the infrared spectra, the —CH₃ stretching and —CH₃ bending modes increase after drying, while the —OH stretch decreases.

### Example 3. Water Absorption of Liner

The liner as described in Example 2 was tested for its water absorption. Additionally, a second liner was tested for its water absorption. This second liner was prepared by the same method as described in Example 2 but with a 50 wt % hydroxy-terminated polydimethylsiloxane solution. A control liner (i.e., uncoated) was also tested.

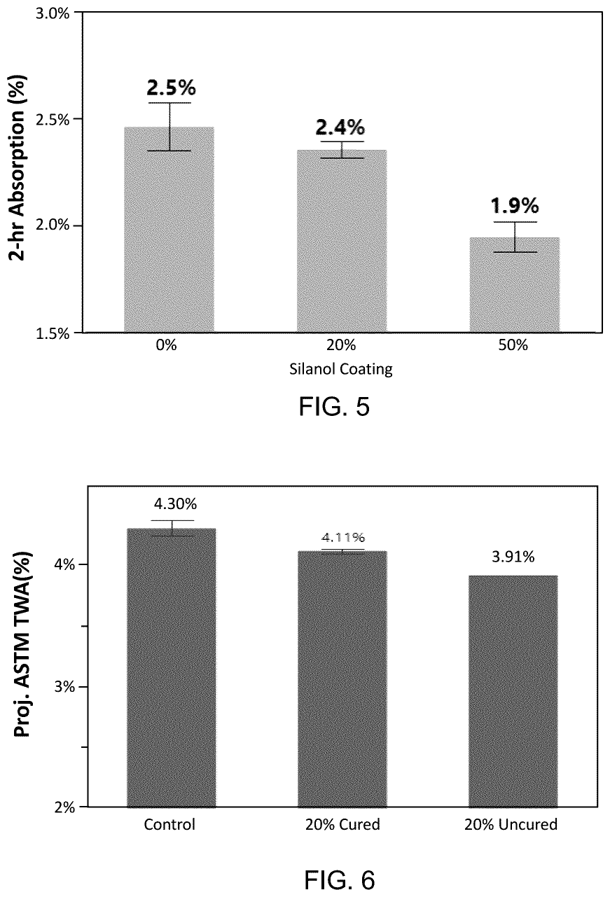

For the water absorption test, each liner was completely submerged in water for 2hours. The weight of the liner was measured before and after being submerged and the difference in weight was calculated as the water absorption (%). The results of these tests are reported in Table 2 and FIG. 5.

TABLE 2

| Sample | 2-hr Absorption (%) |
|---|---|
| Control | 2.5% |
| Liner #1 (20 wt % polysiloxane) | 2.4% |
| Liner #2 (50 wt % polysiloxane) | 1.9% |

From the results above, it is clear that the polysiloxane provides improved water-resistance to the liner. A higher concentration of polysiloxane provides even more resistance.

### Example 4. Water Absorption of Boards with Liner

The liner as prepared in Example 2 was then used to make a gypsum board (Board #1). The gypsum core of the board was prepared by conventional methods from a slurry including stucco, polymethylhydrosiloxane, and guar gum, along with common additives (starch, fluidizer, retarder). The amount of stucco added provided a board weight of 2200 lbs/msf. The polymethylhydrosiloxane and guar gum were added in 6 lbs/msf and 4 lbs/msf, respectively. When preparing the gypsum board, the coated side of the liner is in contact with the gypsum core.

Additionally, a gypsum board was prepared with a second liner (Board #2). This second liner was prepared as described in Example 2 but the solvent was evaporated at room temperature instead of in an oven. A control gypsum board (with conventional paper liner) was also prepared.

The gypsum boards were then tested for their water absorption. To do so, the gypsum boards were first weighed. Then, they were placed on a support in a water bath with a head of 1 inches of water over the top of the sample. Glass rods were placed on top of the sample to keep the sample in contact with the support under the 1 inch of water. The samples were kept under water for 2 hours. Excess water was wiped from the surfaces and edges of the sample and then weighed. The Total Water Absorption was calculated based on the following equation:

$$Total Water Absorption ( \% ) = ( ( {Mass}_{2 hours} - {Mass}_{i n i tial} ) / {Mass}_{i n i tial} ) \times 100$$

Table 3 and FIG. 6 report the Total Water Absorption for a board of the material tested under ASTM C473-17.

TABLE 3

| | ASTM C473-17 Total Water |
|---|---|
| Sample | Absorption (%) |
| Control | 4.30 |
| Board #1 (20 wt % silanol - dried) | 4.11 |
| Board #2 (20 wt % silanol - undried) | 3.91 |

The results above demonstrate that the polysiloxane provides improved water-resistance to the gypsum board.

### Example 5. Water Contact Angle of Liner

As described above, the polysiloxane as described herein is applied to the side of the liner that is ultimately in contact with the gypsum core. This is commonly referred to as the back of the liner. Additionally, it is important that the polysiloxane does not negatively impact the other side (commonly referred to as the face) of the liner that provides the surface for paint and/or joint compound to be applied to.

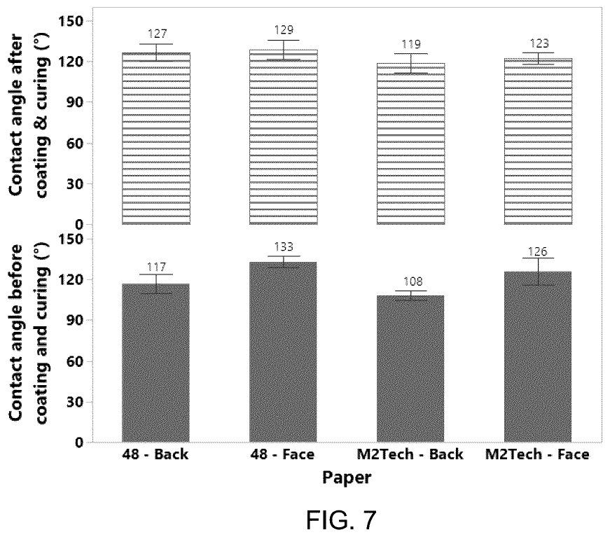

To quantify the effect of the polysiloxane on the liner, the water contact angle of both sides of the liner was measured before and after the coating was applied and dried to the back side of the liner (i.e., the side that would be in contact with the gypsum core). The polysiloxane was applied to two different liners (Liner #3:48 lbs/msf and Liner #4: M2-Tech paper) by the methods as described in Example 2. A drop size analyzer was used to conduct this measurement and the results are reported in Table 4 and FIG. 7.

TABLE 4

| | | Water Contact Angle Before | Water Contact Angle After |
|---|---|---|---|
| | | Coating and Drying with | Coating and Drying with |
| Liner | Side | Polysiloxane (°) | Polysiloxane (°) |
| #3 | Back | 117 | 127 |
| | Face | 133 | 129 |
| #4 | Back | 108 | 119 |
| | Face | 126 | 123 |

The back side was coated for each off these liners, and as can be seen from Table 4, the coating increases the water contact angle by approximately 10° for both of the liners tested. Further, the water contact angle of the uncoated side (the face) was largely unchanged by coating the back side of the liner.

### Example 6. Coating of Liner Surface

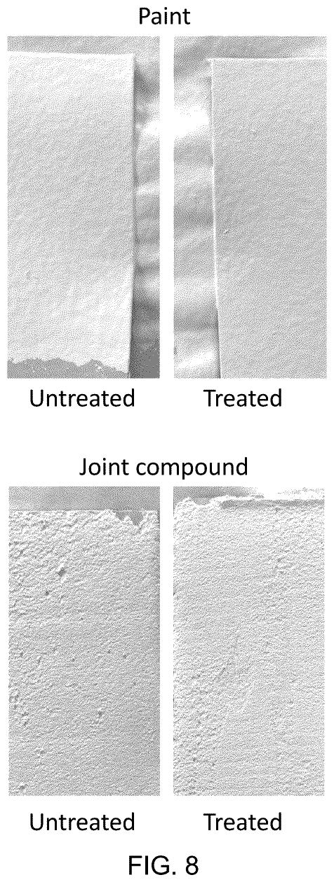

Paper liners treated as described above in Example 2 with a 20 wt % polysiloxane/solvent liquid of polysiloxane and untreated liners were coated with indoor latex paint and with a calcium carbonate-based joint compound. Photographs of the coated liners are shown in FIG. 8. Notably, the treated liners were treated without bleed-through of the polysiloxane/solvent liquid to the second major surface of the liner. As a result, the painting of the first major surface of the treated liner provided a high quality paint coating, indistinguishable from the painted untreated liner. The same was true for the joint compound-coated liners.

In contrast, when a liner was treated with a 50 wt % polysiloxane/solvent liquid, in the same amount and manner as the 20 wt % liquid described above, a paint coating was of relatively lower quality, exhibiting a blotchier coverage.

### Example 7. Crosslinking with Hydrolyzed PMHS

Polymethylhydrosiloxane (PMHS) is often included in the gypsum slurry to provide water-resistance to the gypsum core. Without being bound by theory, it is hypothesized that the polysiloxanes with at least one silanol, as described herein, can cross-link with hydrolyzed PMHS present in the board during the setting and drying of the board. In doing so, a hydrophobic barrier at the interface of the gypsum core and liner is provided that improves the water-resistant properties of the board.

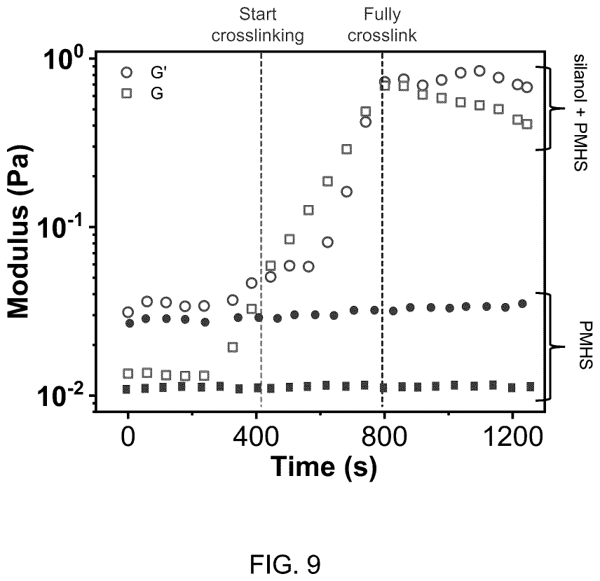

The polysiloxanes as described herein readily react with hydrolyzed PMHS. To evaluate this, the rheology kinetics of a mixture of hydroxy-terminated poly(dimethylsiloxane) (0.15 g) and hydrolyzed PMHS (0.15 g) were measured. Similarly, just PMHS (0.3 g) by itself was measured. The rheology kinetics were measured at 85° C. using DMF (10 mL) and water (6 mL) as solvents. The results are reported in FIG. 9. From FIG. 9, it can be seen that at about 400 seconds, the modulus of the hydroxy-terminated PDMS and PMHS mixture starts to increase and then plateaus around 800 seconds. This rise in modulus is indicative of cross-linking. In contrast, the modulus of just the PMHS does not change overtime.

Various aspects of the disclosure are illustrated by the following enumerated embodiments, which may be combined in any number and in any order not logically or technically inconsistent.

Embodiment 1. A water-resistant gypsum board comprising:
a gypsum core having a first major surface and a second, opposing major surface;
a first liner having a first major surface and a second, opposing major surface, the first liner comprising at at least the first major surface thereof a condensation product of a polysiloxane comprising at least one silanol, the first major surface of the first liner being disposed against the first major surface of the gypsum core; and
a second liner having a first major surface and a second, opposing major surface, the first major surface of the second liner being disposed against the second major surface of the gypsum core.

Embodiment 2. The board of embodiment 1, wherein the first liner is a paper liner.

Embodiment 3. The board of embodiment 1, wherein the first liner is a fiberglass liner, e.g., coated at the second major surface thereof with a polymer-bound mineral layer, such as polymer-bound calcium carbonate.

Embodiment 4. The board of any of embodiments 1-3, wherein the polysiloxane comprises at least two silanols.

Embodiment 5. The board of any of embodiments 1-4, wherein the polysiloxane comprises two silanols.

Embodiment 6. The board of any of embodiments 1-5, wherein the polysiloxane is a hydroxy-terminated polysiloxane.

Embodiment 7. The board of any of embodiments 1-6, wherein the polysiloxane is a hydroxy-terminated alkyl-functional polysiloxane.

Embodiment 8. The board of any of embodiments 1-6, wherein the polysiloxane is a hydroxy-terminated polydimethylsiloxane.

Embodiment 9. The board of any of embodiments 1-6, wherein the polysiloxane is a hydroxy-terminated polymethylhydrosiloxane.

Embodiment 10. The board of any of embodiments 1-9, wherein no more than 10 wt %, e.g., no more than 5 wt % of or no more than 1 wt % of polysiloxane of the liner is polymethylhydrosiloxane or derived therefrom.

Embodiment 11. The board of any of embodiments 1-10, wherein the molar content of dimethylsiloxane units in the polysiloxane is at least 90%, e.g., at least 95% or at least 99% of the non-terminal siloxane units of the polysiloxane.

Embodiment 12. The board of any of embodiments 1-11, wherein the polysiloxane has a number-average molecular weight of no more than 8000 g/mol (e.g., no more than 7000 g/mol or no more than 6000 g/mol).

Embodiment 13. The board of any of embodiments 1-12, wherein the polysiloxane has a number-average molecular weight of at least 1000 g/mol (e.g., at least 2700 g/mol or at least 3000 g/mol).

Embodiment 14. The board of any of embodiments 1-13, wherein the polysiloxane has a viscosity in the range of 25-500 cP (e.g., in the range of 25-300 cP, or 25-150 cP, or 25-100 cP).

Embodiment 15. The board of any of embodiments 1-13, wherein the polysiloxane has a viscosity in the range of 50-500 cP (e.g., in the range of 50-300 cP, or 50-150 cP, or 50-100 cP).

Embodiment 16. The board of any of embodiments 1-15, wherein the condensation product of the polysiloxane is provided without a catalyst.

Embodiment 17. The board of any of embodiments 1-16, wherein the first liner does not include an antimicrobial agent at the first major surface thereof.

Embodiment 18. The board of any of embodiments 1-17, wherein the first liner comprises at least 1 g/m² of the condensation product of the polysiloxane, e.g., at least 3 g/m² or at least 5 g/m², or at least 7 g/m².

Embodiment 19. The board of any of embodiments 1-17, wherein the first liner comprises in the range of 1-50 g/m² of the condensation product of the polysiloxane, e.g., 1-40 g/m², or 1-30 g/m², or 1-20 g/m².

Embodiment 20. The board of any of embodiments 1-17, wherein the first liner comprises in the range of 3-50 g/m² of the condensation product of the polysiloxane, e.g., 3-40 g/m², or 3-30 g/m², or 3-20 g/m².

Embodiment 21. The board of any of embodiments 1-17, wherein the first liner comprises in the range of 5-50 g/m² of the condensation product of the polysiloxane, e.g., 5-40 g/m², or 5-30 g/m², or 5-20 g/m².

Embodiment 22. The board of any of embodiments 1-17, wherein the first liner comprises in the range of 7-50 g/m² of the condensation product of the polysiloxane, e.g., 7-40 g/m², or 7-30 g/m², or 7-20 g/m².

Embodiment 23. The board of any of embodiments 1-22, wherein the condensation product of the polysiloxane extends into a thickness of the first liner.

Embodiment 24. The board of any of embodiments 1-23, wherein the condensation product of the polysiloxane extends into at most 90% (e.g., at most 80%, at most 70%, or at most 60%) of the thickness of the first liner.

Embodiment 25. The board of any of embodiments 1-24, wherein the condensation product of the polysiloxane extends into at least 10% (e.g., at least 20%, at least 30%, or at least 40%) of the thickness of the first liner.

Embodiment 26. The board of any of embodiments 1-25, wherein the first liner has a water contact angle at the second major surface thereof that is no more than 3° (e.g., no more than 2°, or no more than 1°) greater than a water contact angle of an otherwise identical liner that does not have the condensation product of a polysiloxane comprising at least one silanol.

Embodiment 27. The board of any of embodiments 1-26, wherein the first liner has a water contact angle at the first major surface thereof that is at least 6° (e.g., at least 8°, or at least 10°) greater than a water contact angle of an otherwise identical liner that does not have the condensation product of a polysiloxane comprising at least one silanol.

Embodiment 28. The board of any of embodiments 1-27, wherein the first liner has a water contact angle in the range of 115-135° (e.g., in the range of 115-130°, or 115-125°, or 120-135°, or 120-130°, or 120-125°) at the first major surface thereof.

Embodiment 29. The board of any of embodiments 1-28, wherein the first liner has a water contact angle in the range of 120-140° (e.g., in the range of 120-135°, or 120-130°, or 125-140°, or 125-135°, or 125-130°) at the second major surface thereof.

Embodiment 30. The board of any of embodiments 1-29, wherein the first liner has a thickness that is in the range of 10-50 microns, for example, 10-40 microns, or 10-30 microns, or 15-50 microns, or 15-40 microns, or 15-30 microns, or 20-50 microns, or 20-40 microns, or 20-30 microns greater than a thickness of an otherwise identical liner that does not have the polysiloxane comprising at least one silanol and/or the condensation product thereof.

Embodiment 31. The board of any of embodiments 1-30, wherein the first liner has a total water absorption of no more than 10 wt %, e.g., no more than 5 wt %, or no more than 2.5 wt %, based on the weight of the liner.

Embodiment 32. The board of any of embodiments 1-31, wherein the second liner comprises at at least the first major surface thereof a condensation product of a polysiloxane comprising at least one silanol.

Embodiment 33. The board of embodiment 32, wherein the second liner is as described for the first liner in any of embodiments 2-26.

Embodiment 34. The board of any of embodiments 1-33, wherein the gypsum core comprises at least 75 wt % gypsum, e.g., at least 80 wt % gypsum, or at least 85 wt % gypsum.

Embodiment 35. The board of any of embodiments 1-34, wherein gypsum core further comprises one or more additives.

Embodiment 36. The board of embodiment 35, wherein the additives are selected from one or more accelerators, fluidizers, retarders, dispersants, foaming agents, water resistance agents, and/or glass fibers.

Embodiment 37. The board of embodiment 35 or embodiment 36, wherein the additives are present in an amount of no more than 10 wt % (e.g., no more than 8 wt %, or no more than 5 wt %) of the mass of the gypsum core.

Embodiment 38. The board of any of embodiments 1-37, wherein the gypsum core comprises at the first major surface thereof a hydrolysis and condensation product of a polysiloxane having silicon hydride moieties.

Embodiment 39. The board of embodiment 38, wherein the polysiloxane having silicon hydride moieties is polymethylhydrosiloxane.

Embodiment 40. The board of any of embodiments 1-39 having a total water absorption as measured by ASTM C473-17 of no more than 20 wt %, e.g., no more than 17 wt %, or no more than 15 wt % based on the weight of the board.

Embodiment 41. The board of any of embodiments 1-40 having a total water absorption as measured by ASTM C473-17 of no more than 10 wt %, e.g., no more than 7.5 wt %, or no more than 5 wt %, based on the weight of the board.

Embodiment 42. A liner for a gypsum board, the liner having a first major surface and a second, opposing major surface, the liner comprising at at least the first major surface thereof a polysiloxane comprising at least one silanol, and/or a condensation product thereof.

Embodiment 43. The liner of embodiment 42, wherein the liner is a paper liner.

Embodiment 44. The liner of embodiment 42, wherein the liner is a fiberglass liner, e.g., coated at the second major surface thereof with a polymer-bound mineral layer, such as polymer-bound calcium carbonate.

Embodiment 45. A liner of any of embodiments 42-44, as described for the first liner in any of embodiments 2-31.

Embodiment 46. The liner of any of embodiments 42-45, wherein the condensation product of the polysiloxane is provided without a catalyst.

Embodiment 47. The liner of any of embodiments 42-46, wherein the polysiloxane comprising at least one silanol, and/or a condensation product thereof extends into a thickness of the liner.

Embodiment 48. The liner of any of embodiments 42-46, wherein the polysiloxane comprising at least one silanol, and/or a condensation product thereof extends into at most 90% (e.g., at most 80%, at most 70%, or at most 60%) of the thickness of the liner.

Embodiment 49. The liner of any of embodiments 42-46, wherein the polysiloxane comprising at least one silanol, and/or a condensation product thereof extends into at least 10% (e.g., at least 20%, at least 30%, or at least 40%) of the thickness of the liner.

Embodiment 50. The liner of any of embodiments 42-49, comprising at least 1 g/m² of the polysiloxane comprising at least one silanol, and/or a condensation product thereof, e.g., at least 3 g/m² or at least 5 g/m², or at least 7 g/m².

Embodiment 51. The liner of any of embodiments 42-49, comprising in the range of 1-50 g/m² of the polysiloxane comprising at least one silanol, and/or a condensation product thereof, e.g., 1-40 g/m², or 1-30 g/m², or 1-20 g/m².

Embodiment 52. The liner of any of embodiments 42-49, comprising in the range of 3-50 g/m² of the polysiloxane comprising at least one silanol, and/or a condensation product thereof, e.g., 3-40 g/m², or 3-30 g/m², or 3-20 g/m².

Embodiment 53. The liner of any of embodiments 42-49, comprising in the range of 5-50 g/m² of the polysiloxane comprising at least one silanol, and/or a condensation product thereof, e.g., 5-40 g/m², or 5-30 g/m², or 5-20 g/m².

Embodiment 54. The liner of any of embodiments 42-49, comprising in the range of 7-50 g/m² of the polysiloxane comprising at least one silanol, and/or a condensation product thereof, e.g., 7-40 g/m², or 7-30 g/m², or 7-20 g/m².

Embodiment 55. A method for making a liner of any of embodiments 42-54, the method comprising disposing a liquid comprising the polysiloxane comprising at least one silanol and a solvent on a first surface of a liner sheet, and allowing the liquid to dry by evaporation of the solvent.

Embodiment 56. The method of embodiment 55, wherein the solvent has a boiling point no more than 120° C.

Embodiment 57. The method of embodiment 55 or embodiment 56, wherein the solvent is a C₁-C₄ alcohol, e.g., isopropanol.

Embodiment 58. The method of any of embodiments 55-57, wherein the polysiloxane is present in the liquid in an amount of at least 10 wt % (e.g., at least 15 wt %, at least 20 wt %, at least 25 wt %, at least 30 wt %).

Embodiment 59. The method of any of embodiments 55-58, wherein the polysiloxane is present in the liquid in an amount in the range of 10 to 60 wt % (e.g., in the range of 10 to 50 wt %, or 10 to 40 wt %, or 10 to 30 wt %, or 15 to 60 wt %, 15 to 50 wt %, or 15 to 40 wt %, or 15 to 30 wt %, or 20 to 60 wt %, or 20 to 50 wt %, or 20 to 40 wt %, or 25 to 60 wt %, or 25 to 50 wt %, or 25 to 40 wt %, or 30 to 60 wt %, or 30 to 50 wt %, or 30 to 40 wt %).

Embodiment 60. The method of any of embodiments 55-59, wherein the liquid has a viscosity in the range of 1-10 cP (e.g., in the range of 1-5 cP, or 1-3 cP, or 2-10 cP, or 2-5 cP, or 2-3 cP).

Embodiment 61. The method of any of embodiments 55-60, wherein the liquid is disposed on the paper sheet by rod coating, curtain coating, spraying, printing, reverse roll coating, or gravure coating.

Embodiment 62. The method of any of embodiments 55-61, wherein the drying is conducted at a temperature of at least 80° C. (e.g., at least 90° C., or at least 100° C.).

Embodiment 63. The method of any of embodiments 55-62, wherein the drying is conducted at a temperature in the range of 80-120° C. (e.g., in the range of 80-110° C., or 80-100° C., or 90-120° C., or 90-110° C., or 90-100° C., or 100-120° C., or 100-110° C.).

Embodiment 64. The method of any of embodiments 55-63, wherein the drying is conducted for a time sufficient to provide the condensation product (e.g., at least 30 minutes, at least 45 minutes, or at least 60 minutes).

Embodiment 65. The method of any of embodiments 55-64, wherein the drying is conducted for a time in the range of 30-90 minutes (e.g., in the range of 30-75 minutes, or 30-60 minutes, or 45-90 minutes, or 45-75 minutes, or 45-60 minutes).

Embodiment 66. The method of any of embodiments 55-65, wherein the polysiloxane comprising at least one silanol extends into a thickness of the first liner.

Embodiment 67. The method of any of embodiments 55-65, wherein the polysiloxane comprising at least one silanol extends into at most 90% (e.g., at most 80%, at most 70%, or at most 60%) of the thickness of the first liner.

Embodiment 68. The method of any of embodiments 55-65, wherein the polysiloxane comprising at least one silanol extends into at least 10% (e.g., at least 20%, at least 30%, or at least 40%) of the thickness of the first liner.

Embodiment 69. The method of any of embodiments 55-68, wherein the liquid is disposed on the first major surface of the paper sheet so that it does not wet the second major surface of the paper.

Embodiment 70. The method of any of embodiments 55-69, wherein the amount of the polysiloxane applied to the liner is at least 1 g/m², and/or a condensation product thereof, e.g., at least 3 g/m² or at least 5 g/m², or at least 7 g/m².

Embodiment 71. The method of any of embodiments 55-69, wherein the amount of the polysiloxane applied to the liner is in the range of 1-50 g/m², e.g., 1-40 g/m², or 1-30 g/m², or 1-20 g/m².

Embodiment 72. The method of any of embodiments 55-69, wherein the amount of the polysiloxane applied to the liner is in the range of 3-50 g/m², e.g., 3-40 g/m², or 3-30 g/m², or 3-20 g/m².

Embodiment 73. The method of any of embodiments 55-69, wherein the amount of the polysiloxane applied to the liner is in the range of 5-50 g/m², e.g., 5-40 g/m², or 5-30 g/m², or 5-20 g/m².

Embodiment 74. The method of any of embodiments 55-69, wherein the amount of the polysiloxane applied to the liner is in the range of 7-50 g/m², e.g., 7-40 g/m², or 7-30 g/m², or 7-20 g/m².

Embodiment 75. A liner (e.g., of any of embodiments 42-54) made by the process of any of embodiments 55-74.

Embodiment 76. A board of any of embodiments 1-41, wherein the liner is a liner made by the process of any of embodiments 55-74.

Embodiment 77. A method of producing a water-resistant gypsum board (e.g., of any of embodiments 1-41), the method comprising:
providing a first liner having a first major surface and a second, opposing major surface, the first liner comprising at at least the first major surface thereof a polysiloxane comprising at least one silanol and/or a condensation product thereof;
disposing one or more calcium sulfate slurries between the first liner and a second liner, at least one calcium sulfate slurry being disposed against the first major surface of the first liner;
allowing the one or more calcium sulfate slurries to set to form a set gypsum body; and
drying the set gypsum body to provide a gypsum core disposed between the first liner and the second liner, and in contact with the first major surface of the first liner.

Embodiment 78. The method of embodiment 77, wherein the first liner is a liner according to any of embodiments 42-54 and 75.

Embodiment 79. The method of any of embodiments 77-78, wherein the calcium sulfate slurry is formed by combining stucco and water in weight ratio of no more than 3:1.

Embodiment 80. The method of any of embodiments 77-78, wherein the calcium sulfate slurry is formed by combining stucco and water in a weight ratio in the range of 3:1 to 1:2.

Embodiment 81. The method of any of embodiments 77-80, wherein the drying occurs at a temperature in the range of 50-350° C. to provide the gypsum core.

Embodiment 82. The method of any of embodiments 77-81, wherein the drying occurs at a temperature in the range of 100-350° C. (e.g. 100-325° C., or 100-300° C., or 150-350° C., or 150-325° C., or 150-300° C., or 200-350° C., or 200-325° C., or 200-300° C.) to provide the gypsum core.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice. Thus, before the disclosed processes and devices are described, it is to be understood that the aspects described herein are not limited to specific embodiments, apparatuses, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. It will be further understood that the endpoints of each of the ranges are significant both in relation to the other endpoint, and independently of the other endpoint.

All methods described herein can be performed in any suitable order of steps unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

Unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Some embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, it is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

We claim:

1. A water-resistant gypsum board comprising:
a gypsum core having a first major surface and a second, opposing major surface;
a first liner having a first major surface and a second, opposing major surface, the first liner comprising at at least the first major surface thereof a condensation product of a polysiloxane comprising at least one silanol, the first major surface of the first liner being disposed against the first major surface of the gypsum core; and
a second liner having a first major surface and a second, opposing major surface, the first major surface of the second liner being disposed against the second major surface of the gypsum core.

2. The board of claim 1, wherein the first liner is a paper liner.

3. The board of claim 1, wherein the polysiloxane comprises at least two silanols.

4. The board of claim 1, wherein the polysiloxane is a hydroxy-terminated polysiloxane.

5. The board of claim 1, wherein the polysiloxane is a hydroxy-terminated polydimethylsiloxane.

6. The board of claim 1, wherein no more than 10 wt % of polysiloxane of the liner is polymethylhydrosiloxane or derived therefrom.

7. The board of claim 1, wherein the polysiloxane has a number-average molecular weight of no more than 8000 g/mol.

8. The board of claim 1, wherein the polysiloxane has a viscosity in the range of 25-500 cP.

9. The board of claim 1, wherein the condensation product of the polysiloxane is provided without a catalyst.

10. The board of claim 1, wherein the first liner comprises in the range of 5-50 g/m² of the condensation product of the polysiloxane.

11. The board of claim 1, wherein
the first liner has a water contact angle at the second major surface thereof that is no more than 3° greater than a water contact angle of an otherwise identical liner that does not have the condensation product of a polysiloxane comprising at least one silanol; and
the first liner has a water contact angle at the first major surface thereof that is at least 6° greater than a water contact angle of an otherwise identical liner that does not have the condensation product of a polysiloxane comprising at least one silanol.

12. The board of claim 1, wherein the liner is made by a process comprising: disposing a liquid comprising the polysiloxane comprising at least one silanol and a solvent on a first surface of a liner sheet without wetting a second opposed surface of the liner sheet, and allowing the liquid to dry by evaporation of the solvent.

13. The board of claim 1, wherein the first liner has a total water absorption of no more than 5 wt %, based on the weight of the liner.

14. The board of claim 1, the board having a total water absorption as measured by ASTM C473-17 of no more than 7.5 wt %, based on the weight of the board.

15. A liner for a gypsum board, the liner having a first major surface and a second, opposing major surface, the liner comprising at at least the first major surface thereof a polysiloxane comprising at least one silanol, and/or a condensation product thereof.

16. The liner of claim 15, wherein
the liner is a paper liner;
the liner comprises in the range of 5-50 g/m² of the polysiloxane comprising at least one silanol, and/or a condensation product thereof;
the liner has a water contact angle at the second major surface thereof that is no more than 3° greater than a water contact angle of an otherwise identical liner that does not have the condensation product of a polysiloxane comprising at least one silanol; and
the liner has a water contact angle at the first major surface thereof that is at least 6° greater than a water contact angle of an otherwise identical liner that does not have the condensation product of a polysiloxane comprising at least one silanol.

17. A method for making a liner of claim 15, the method comprising disposing a liquid comprising the polysiloxane comprising at least one silanol and a solvent on a first surface of a liner sheet, and allowing the liquid to dry by evaporation of the solvent.

18. A method of producing a water-resistant gypsum board of claim 1, the method comprising:
providing a first liner having a first major surface and a second, opposing major surface, the first liner comprising at at least the first major surface thereof a polysiloxane comprising at least one silanol and/or a condensation product thereof;
disposing one or more calcium sulfate slurries between the first liner and a second liner, at least one calcium sulfate slurry being disposed against the first major surface of the first liner;
allowing the one or more calcium sulfate slurries to set to form a set gypsum body; and
drying the set gypsum body to provide a gypsum core disposed between the first liner and the second liner, and in contact with the first major surface of the first liner.

19. The board of claim 18, wherein the first liner is made by a process comprising: disposing a liquid comprising the polysiloxane comprising at least one silanol and a solvent on a first surface of a liner sheet without wetting a second opposed surface of the liner sheet, and allowing the liquid to dry by evaporation of the solvent.
